(19) United States
(12) Patent Application Publication
(10) Pub. No.: US 2007/0152405 A1
(43) Pub. Date: Jul. 5, 2007

(54) Seal

(75) Inventors: Chih-Yung Wen, Taichung City (TW); An-Shik Yang, Taipei City (TW); Yen-Ting Li, Nantou County (TW); Pang-Chi Hsiao, Changhua County (TW); Chun-Hsiang Tseng, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: NAK SEALING TECHNOLOGIES CORPORATION, Nantou City (TW)

(21) Appl. No.: 11/350,113

(22) Filed: Feb. 9, 2006

(30) Foreign Application Priority Data
Dec. 29, 2005 (TW) 94147339

(51) Int. Cl. F16J 15/32

(52) U.S. Cl. 277/559

(57) ABSTRACT

A seal includes an annular main member. A seal lip is projected inwards from the annular main member, wherein the seal lip has a tip and an outer inclined surface a plurality of helixes are projected from the outer inclined surface of the seal lip, each of which has a first extending section along a first direction and a second extending section along a second direction connected to the first extending section. The first extending section has a first free end and the second extending section has a second free end, and a junction of the first extending section and the second extending section is a turning point. A first angle is between each of the first directions and a corresponding tangent line of the tip, and a second angle is between each of the first direction and the second direction.

### BACKGROUND OF THE INVENTION

1. Field of the Invention

The present invention relates generally to a device for a rotary shaft to isolate air and oil, and more particularly to a seal having high pumping effect.

2. Description of the Related Art

FIG. 1 shows a lip type seal 1, which has a rubber lip portion 1a projected inwards along a diameter direction. In use, the seal 1 is fitted to a rotary shaft 2 with the lip portion 1a pressing the rotary shaft 2 to cause deformation. As a result, the seal 1 isolates air and oil. It defines the seal 1 with an air side 101 and an oil side 102. The function of the seal 1 is to prevent oil running to the air side 101 from the oil side 102.

As shown in FIG. 2, there is an oil film 3 between the lip portion 1a and the rotary shaft 2, which serves both function of isolation and lubrication. When the lip portion 1a presses the rotary shaft 2 to cause deformation and rotates relative to the rotary shaft 2, it produces a plurality of fine oil marks 3a on the rotary shaft 2. These oil marks 3a have opposite ends communicated with the air side 101 and the oil side 102 respectively that provide “bridges” to flow the oil back to the oil side 102 from the air side 101.

To increase the capacity of flowing oil back to the oil side 102, there was a seal with helixes, as shown in FIG. 3. The seal 4 has a rubber lip portion 4a and a plurality of helixes 5 on the lip portion 4a. The helixes 5 are straight flange-like members projected form an inclined side 101 of the lip portion 4a, which face the air side 101. As shown in FIG. 4 and FIG. 5, the helixes 5 are leaned around the circle and have the same interval therebetween. There are predetermined angles between the extending lines of the helixes 5 and the tangent lines of the corresponding tip 4c of the lip portion 4a. This angle is defined as a helix angle θ. When the rotary shaft 6 rotates counterclockwise, the overflowed oil is blocked by the helixes 5 and is guided by the helixes 5 to flow back to the oil side 102. It is called “pumping”. The more “pumping” occurred, the better performance of the seal has, in other words, the higher “pumping rate” the seal has.

As shown in FIG. 6 and FIG. 7, in the test of the seal, if the number of the helixes is increased or the helix angle is decreased, the seal will has higher pumping rate. But it will increase the difficulty to manufacture the helixes when the helix angle is decreased, and the number of the helixes will be decrease when the helix angle is decreased. In practice, if the helix angle θ is less than 22.5 degrees, above problems will occurred. In conclusion, the conventional seal still has to be improved.

### SUMMARY OF THE INVENTION

The primary objective of the present invention is to provide a seal with higher pumping.

According to the objective of the present invention, a seal comprises an annular main member having a center axis. A seal lip is projected inwards from the annular main member to the center axis, wherein the seal lip has a tip and an outer inclined surface a plurality of helixes are projected from the outer inclined surface of the seal lip, each of which has a first extending section along a first direction and a second extending section along a second direction connected to the first extending section. The first extending section has a first free end and the second extending section has a second free end, and a junction of the first extending section and the second extending section is a turning point. A first angle is between each of the first directions and corresponding tangent lines of the tip, and a second angle is between each of the first directions and the second directions.

### BRIEF DESCRIPTION OF THE DRAWINGS

FIG. 1 is a sectional view of the conventional lip type seal;

FIG. 2 is an enlarged view in parts of FIG. 1;

FIG. 3 is a sectional view of the conventional lip type seal with helixes;

FIG. 4 is a lateral view of the conventional lip type seal with helixes;

FIG. 5 is an enlarged view in parts of FIG. 4;

FIG. 6 is a diagram showing the relationship of the number of helixes and pumping ratio;

FIG. 7 is a diagram showing the relationship of the helix angle and pumping ratio;

FIG. 8 is a sectional view of a preferred embodiment of the present invention, showing the conventional seal fitted to the rotary shaft;

FIG. 9 is a left view of FIG. 8, showing the air side of the seal;

FIG. 10 is a sectional view along 10-10 line of FIG. 9;

FIG. 11 is an enlarged view in parts of FIG. 9;

FIG. 12 is a sectional view of the preferred embodiment of the present invention, showing the helixes;

FIG. 13 is a sectional view along 13-13 line of FIG. 12;

FIG. 14 is a sectional view along 14-14 line of FIG. 12;

FIG. 15 is a sectional view along 15-15 line of FIG. 12;

FIG. 16 is a sectional view along 16-16 line of FIG. 12;

FIG. 17 is similar to FIG. 12, showing the helixes with various widths;

FIG. 18 is a sectional view along 18-18 line of FIG. 17;

FIG. 19 is a sectional view along 19-19 line of FIG. 17;

FIG. 20 is a sectional view along 20-20 line of FIG. 17; and

FIG. 21 is similar to FIG. 10, showing the seal with dust proof lip.

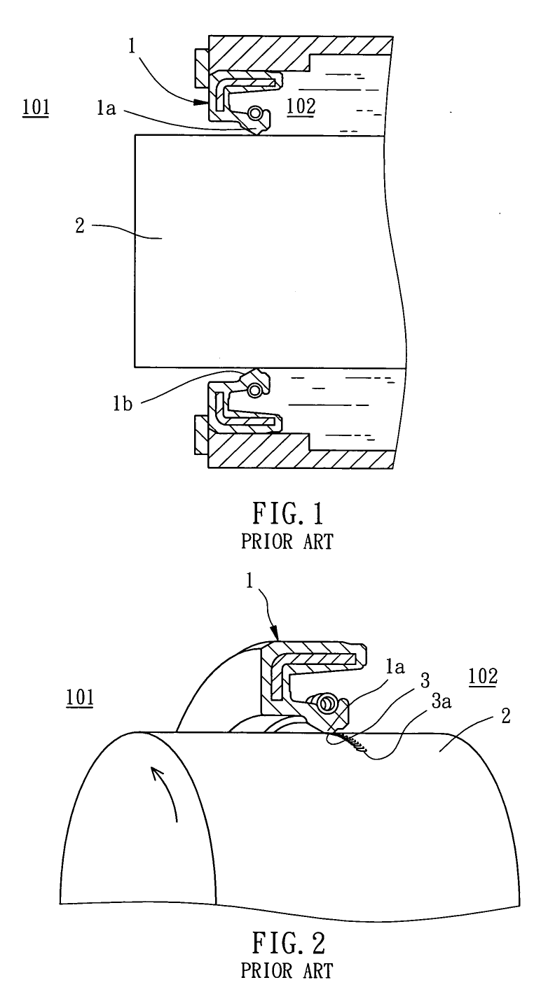

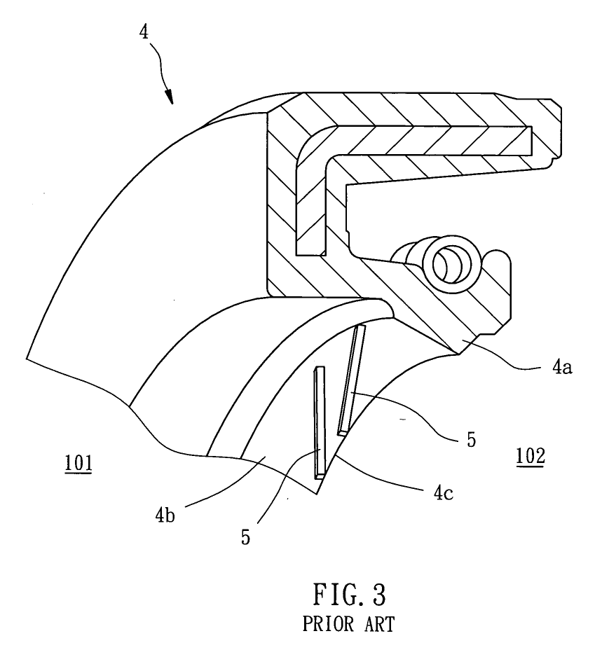

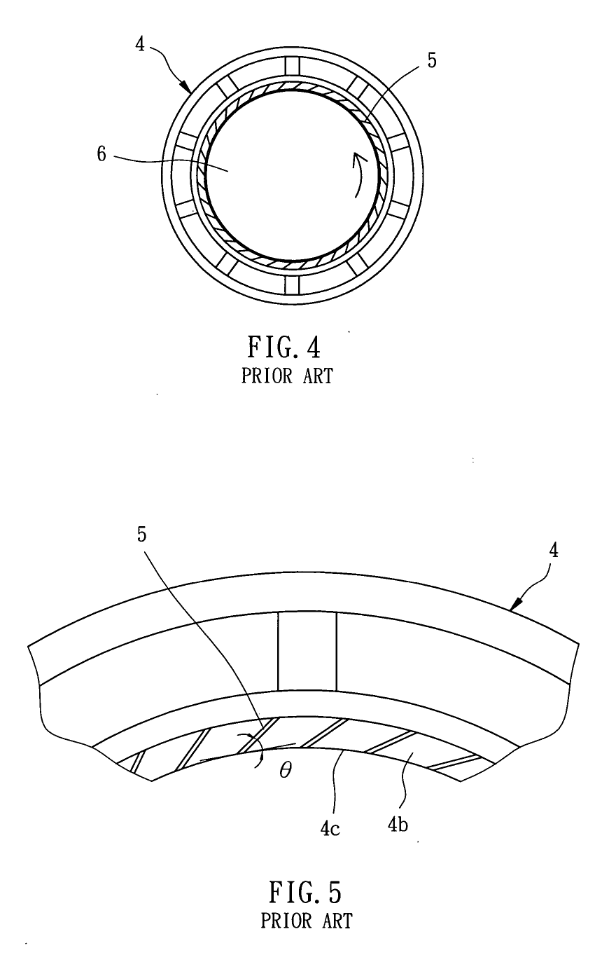

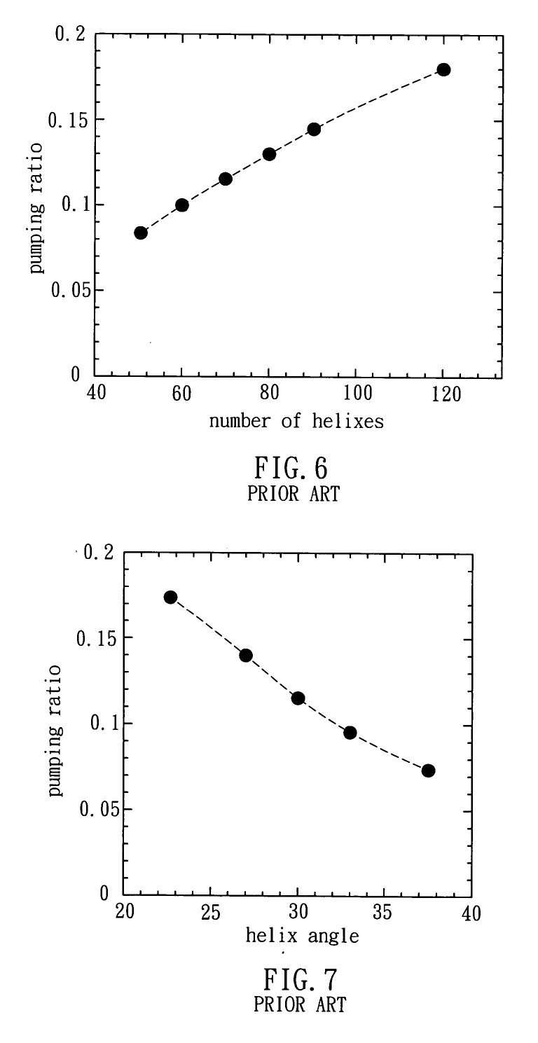

### DETAILED DESCRIPTION OF THE INVENTION

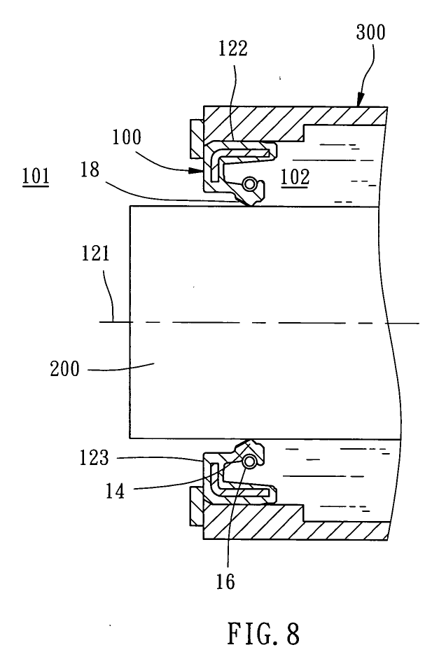

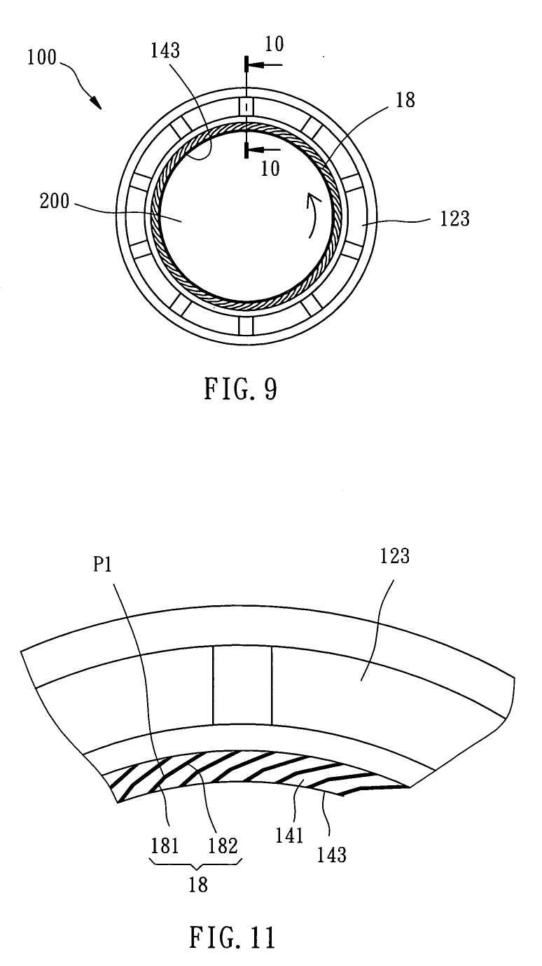

As shown in FIG. 8 and FIG. 9, a seal 100 of the preferred embodiment of the present invention is fitted to a rotary shaft 200, which rotates counterclockwise. The seal 100 is between the rotary shaft 200 and an oil container 300 to isolate air and the oil in the oil container 300. The seal 100 has an air side 101 and an oil side 102.

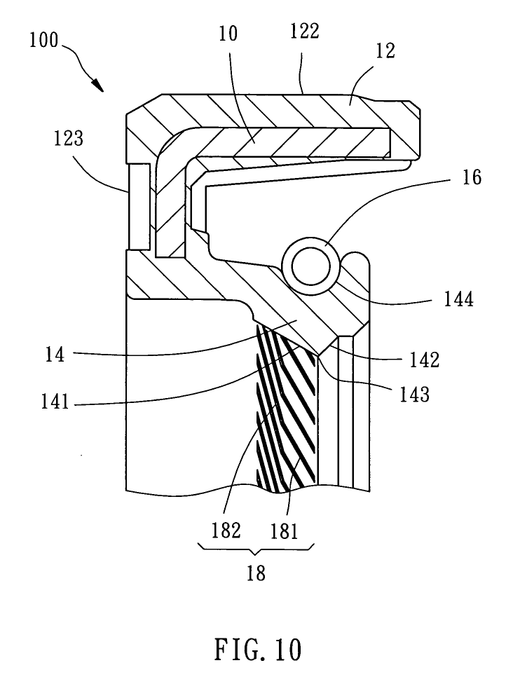

As shown in FIG. 10, the seal 100 includes an annular frame member 10, an annular main member 12, a seal lip 14, an elastic ring 16 and a plurality of helixes 18. The annular main member 12, the seal lip 14 and the helixes are made of rubber and made in a single unit.

The annular frame member 10 is made of metal, which is the main structure of the seal 100. The annular frame member 10 has sufficient strength to prevent the seal 100 of the present invention from deformation.

The annular main member 12 is covered on the annular frame member 10, which has a center axis 121, an outer circumference 122 and an outer surface 123. As shown in FIG. 8, the assembled seal 100 of the present invention has the outer circumference 122 touching the sidewall of the oil container 300 and the outer surface 123 facing the air side 101.

The seal lip 14 is projected inwards from the annular main member 12 to the center axis 121, which has an outer inclined face 141, and inner inclined face 142 and a tip 143 on an outer edge of the outer inclined face 142. The seal lip 14 further has an annular slot 144 on a side opposite to the tip 143.

The elastic ring 16 is received in the annular slot 144 to urging the seal lip 14 pressing the rotary shaft 200 when the seal 100 is fitted to the rotary shaft 200 to cause the seal lip 14 deformation.

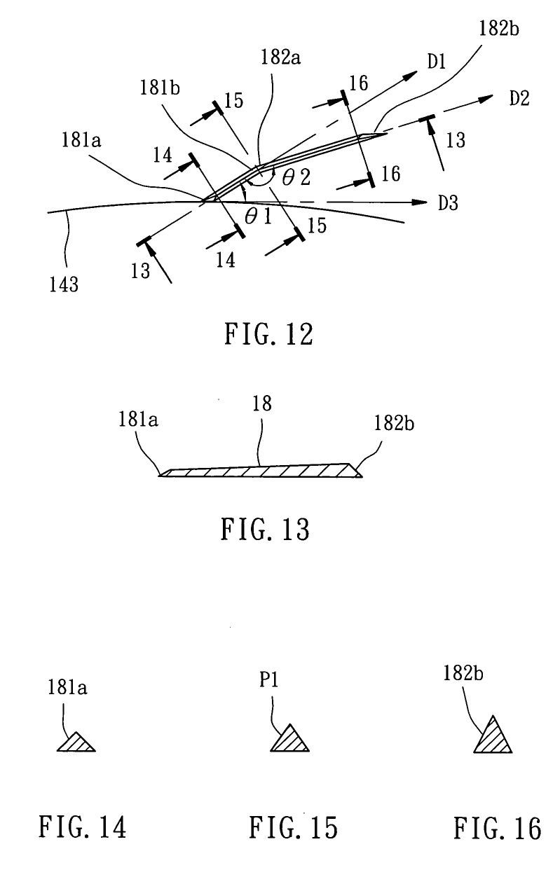

The helixes 18 are projected from the outer inclined face 141 in an annular pattern. As shown in FIG. 11 and FIG. 12, each of the helixes 18 has a first extending section 181 along a first direction D1 and a second extending section 182 along a second direction D2. The first and second extending sections are substantially in a straight line. There is a first angle θ1, which is an acute angle, between the first direction D1 and a tangent line D3 of the corresponding tip 143, and there is a second angle θ2, which is an obtuse angle, between the first direction D1 and the second direction D2. The first angle θ1 is preferred in a range between 20 degrees and 40 degrees, and the first angle θ1 is 22.5 degrees in the present invention. The second angle θ2 is preferred in a range between 150 degrees and 180 degrees, and the second angle θ2 is 172.5 degrees in the present invention.

In addition, each of the helixes 18 has a first head end 181a and a first tail end 181b on the first extending section 181, wherein the first head ends 181a substantially touch the tip 143, and has a second head end 182a and a second tail end 182b on the second extending section 182, wherein the second head ends 182a are connected to the first tail ends 181b respectively. It defines a turning point P1 at the junction of the first tail end 181b and the second head end 182. As shown in FIGS. 13 to 16, the helixes 18 are gradually higher from the first head ends 181a of the first extending sections 181 to the second tail ends 182b of the second extending sections 182.

Above is the description of the structure of the seal 100 of the present invention. Because the angles between the first extending sections 181 and the second extending sections 182 of the helixes 18 are 22.5 degrees, and the second extending sections 182 of the helixes 18 are connected to the corresponding the first tail ends 181b of the first extending sections 181 with obtuse angle therebetween, it doesn't difficult to manufacture the seal 100 of the present invention, and it can raise the number of the helixes 18 in conclusion, the present invention provides the seal 100 with two-section helixes 18, which have smaller helix angle (the first angle θ1) and a greater number of helixes 18, to increase the pumping ratio and reduce the loss of lubricator.

The heights of the helixes 18 are gradually changed, which can increase the area to block lubricator to flow back the lubricator. It has to be mentioned that the two-section helixes can increase the pumping ratio alone without the helixes with gradually changed heights. In other words, it also can make the seal with two-section helixes but the gradually changed heights.

In addition, the turning points P1 are preferred closed to the corresponding first head ends 181a, which is, the first extending sections 181 are shorter than the second extending sections 182. With this character, the lubricator will be blocked by the first extending sections 181 and the second extending sections 182 sooner and flow back to oil side 102. In conclusion, the position of the turning points P1 will affect the capacity of pumping.

The inventor takes a test of the seal of the present invention and the conventional seal. The result shows the seal with two-section helixes is superior to the seal with single-section helixes. We use the same rotary shaft, lubricator (SAE 20), the same pressure at air side and oil side (one atmospheric pressure) and the same helix angle. The result is shown in the following table:

| | Helix | | |
|---|---|---|---|
| | Single section | Two sections | Pumping ratio |
| speed | (ml/min) | (ml/min) | increase |
| 2000 rpm | 0.0572 | 0.0751 | 31% |
| 3000 rpm | 0.0864 | 0.1133 | 31% |
| 4000 rpm | 0.1160 | 0.1520 | 31% |
| 5000 rpm | 0.1460 | 0.1911 | 31% |
| 6000 rpm | 0.1763 | 0.2307 | 31% |

The result shows the seal with two-section helixes is superior to the seal with single-section helixes.

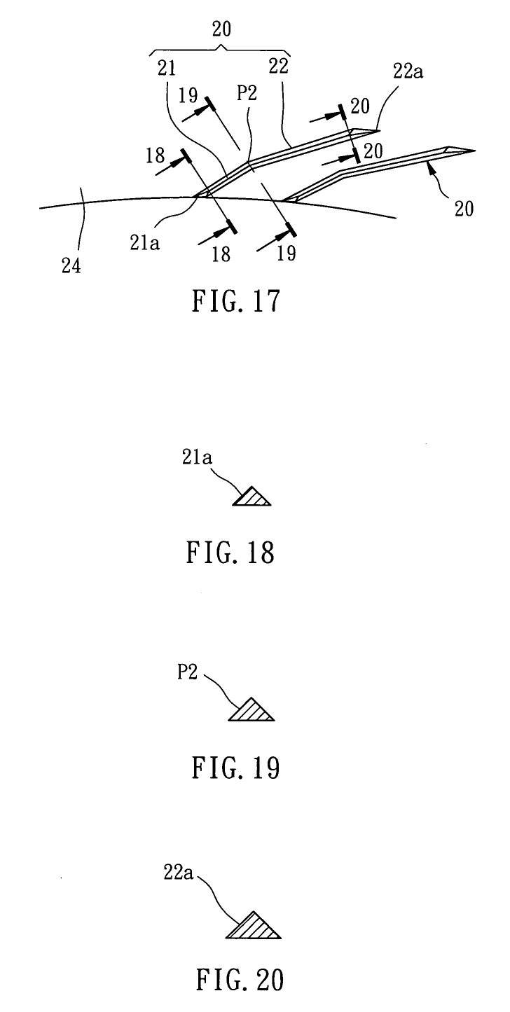

In addition, to reduce the leakage of lubricator, the present invention provides a new design for the width between the two-section helixes and the seal lip. As shown in FIGS. 17 to 20, the helix 20 has a first extending section 21 with a first free end 21a and a second extending section 22 with a second free end 22a. The height of the helix 20 is gradually increased as above. The width of a bottom of the helix 20 is gradually increased from the first free end 21a to the second free end 22a. In other words, the interval between the neighboring helixes 20 is narrow at the second free ends 22a than at the first free ends 21a. It can reduce the loss of lubricator.

Same as above, there is a turning point P2 between each first extending section 21 and second extending section 22. The turning point P2 closes to the first free end 21a.

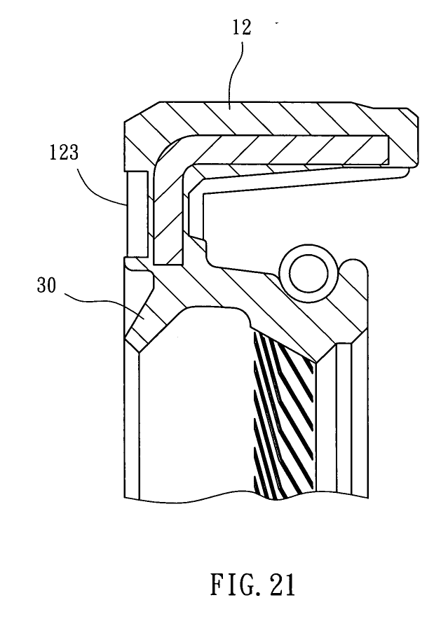

To enhance the seal capacity, the seal 100 of the present invention is provided with a dust-proof lip 30, as shown in FIG. 21, which is connected to the annular main member 12 and adjacent to the outer surface 123.

It has to be mentioned that the orientation of the helixes is designed for counterclockwise rotating rotary shaft. For a clockwise rotating rotary shaft, the orientation of the helixes is opposite to that of shown in FIGS. of the present invention.

Although the invention has been explained in relation to its preferred embodiment, it is to be understood that many other possible modifications and variations can be made without departing from the spirit and scope of the invention as hereinafter claimed.

What is claimed is:

1. A seal, comprising:
an annular main member having a center axis;
a seal lip projected inwards from the annular main member to the center axis, wherein the seal lip has a tip and an outer inclined surface; and
a plurality of helixes projected from the outer inclined surface of the seal lip, each of which has a first extending section along a first direction and a second extending section along a second direction connected to the first extending section, wherein ends of the first extending sections are substantially connected to the tip, and a first angle is between each of the first directions and corresponding tangent lines of the tip, and a second angle is between each of the first directions and the second directions.

2. The seal as defined in claim 1, wherein the first extending sections of the helixes have a first head end and a first tail end, and the first extending section has a height, which is gradually higher from the first head end to the first tail end.

3. The seal as defined in claim 1, wherein the second extending sections of the helixes have a second head end and a second tail end, and the second extending section has a height, which is gradually higher from the second head end to the second tail end.

4. The seal as defined in claim 1, wherein bottoms of the first extending sections of the helixes, which are connected to the seal lip, are gradually wider from the first head end to the first tail end.

5. The seal as defined in claim 1, wherein bottoms of the second extending sections of the helixes, which are connected to the seal lip, are gradually wider from the second head end to the second tail end.

6. The seal as defined in claim 1, wherein the first extending section has a length greater than that of the second extending section.

7. The seal as defined in claim 1, wherein the first angles of the helixes are acute angles.

8. The seal as defined in claim 7, wherein the first angles are between 20 degrees and 40 degrees.

9. The seal as defined in claim 1, wherein the second angles of the helixes are obtuse angles.

10. The seal as defined in claim 9, wherein the second angles are between 150 degrees and 180 degrees.

11. The seal as defined in claim 1, further comprising an elastic ring received in an annular slot of the seal lip on a side opposite to the tip.

12. The seal as defined in claim 1, further comprising a dust-proof lip, wherein the annular main member further has an outer surface, and the dust-proof lip is connected to the annular main member and projected inwards to the center axis, and the dust-proof lip is closed to the outer surface.

13. The seal as defined in claim 1, further comprising an annular frame, wherein the annular main member covers the annular frame.

14. A seal, comprising:
an annular main member having a center axis;
a seal lip projected inwards from the annular main member to the center axis, wherein the seal lip has a tip and an outer inclined surface; and
a plurality of helixes projected from the outer inclined surface of the seal lip, each of which has a first free end, a second free end and a turning point between the first free end and the second free end.

15. The seal as defined in claim 14, wherein each of helixes has a first extending section along a first direction and a second extending section along a second direction connected to the first extending section, and the first extending section has the first free end and is substantially connected to the tip, and a first angle is between the first direction and a corresponding tangent line of the tip, and a position where the first extending section is connected to the second extending position is the turning point.

16. The seal as defined in claim 15, wherein a distance between the turning point and the second free end is greater than that between the turning point and the first free end.

17. The seal as defined in claim 15, wherein the first angles of the helixes are acute angles.

18. The seal as defined in claim 17, wherein the first angles are between 20 degrees and 40 degrees.

19. The seal as defined in claim 15, wherein the second angles of the helixes are obtuse angles.

20. The seal as defined in claim 19, wherein the second angles are between 150 degrees and 180 degrees.
